(19) United States
(12) Patent Application Publication
(10) Pub. No.: US 2008/0118054 A1
(43) Pub. Date: May 22, 2008

(54) TELEPHONE SYSTEM AND METHOD

(76) Inventor: JAMES MICHAEL MCARDLE, Austin, TX (US)

Correspondence Address: IBM CORPORATION (SS), C/O STREETS & STEELE, 13831 NORTHWEST FREEWAY, SUITE 355, HOUSTON, TX, 77040, US

(21) Appl. No.: 11/561,426

(22) Filed: Nov. 20, 2006

(51) Int. Cl. H04M 1/00

(52) U.S. Cl. 379/388.02

(57) ABSTRACT

An improved telephone system and method of managing telephone calls. In one embodiment, a telephone system includes a speakerphone and a handset. A plurality of telephone lines or channels is available for conducting each of a corresponding plurality of telephone calls. In one instance, a first call may be routed to the handset, while a second call is routed to the speakerphone. The first and second telephone calls may be conducted simultaneously. An optional third telephone call may be conducted on a third line routed to a headset, such as to a Bluetooth device, so that all three telephone calls may be conducted simultaneously.

### BACKGROUND OF THE INVENTION

1. Field of the Invention

The present invention relates to telephony in general, and, in particular, to methods and devices for managing telephone calls.

2. Description of the Related Art

Being placed “on hold” occasionally is an inconvenience experienced by just about anyone who uses a telephone. Businesses are under increasing competitive pressure to field customer telephone calls in the most efficient manner possible. Telephone hold times have increased over the years as businesses strive to optimize the delicate balance between providing timely and courteous service to a growing customer base while streamlining costs to remain profitable.

Simultaneously, individuals endeavor to maximize personal productivity in their increasingly busy professional and personal lives. One challenge faced by telephone users today is, therefore, to minimize the period of non-productivity that occurs when their telephone call is placed on hold. It is often tempting to put the telephone down to grab a cup of coffee, type a letter, or perform any other task that one might hope to achieve during the timespan one is typically on hold. Unfortunately, it is risky to place the handset down or leave the call unattended while on hold by the other party, because once a customer service representative returns to the line, a user typically has only a brief moment to respond before being disconnected by the representative. Being disconnected compounds non-productivity, in that the disconnected telephone user must call back and return to the end of the hold queue.

One way that people manage calls and maximize productivity while on hold is to place the call on speakerphone and carry on other tasks while waiting for a customer service representative to return to the line. A limitation of using the speakerphone in this manner is that it prevents the user from making another telephone call. Unfortunately, to make another call conventionally requires switching to another line for a period of time. Again, the user risks being disconnected from the originally placed call while talking on the other line, because a conventional telephone system will not alert the user when the customer service representative has returned to the original line.

An improved telephone system is desired for managing telephone calls and maximizing productivity. The improved telephone system might, for example, allow a user to make another telephone call while on hold, with minimal risk of being disconnected. More generally, the improved system would provide a better way to conduct telephone calls individually, as well as to manage multiple telephone calls.

### SUMMARY OF THE INVENTION

One embodiment of the invention provides a telephone that includes a handset and a speakerphone, each configured for two-way audio communication. A controller is in electronic communication with the handset and with the speakerphone. The controller is configured for conducting a first call on the handset and a second call on the speakerphone concurrently.

Another embodiment of the invention provides a method that includes routing a first telephone call to a handset, routing a second telephone call to a speakerphone, and concurrently conducting the first telephone call on the handset and the second telephone call on the speakerphone.

Yet another embodiment of the invention provides a machine-accessible medium that contains instructions which, when executed by a machine, cause the machine to route a first telephone call to a handset of a telephone, route a second telephone call to a speakerphone of the telephone, and concurrently conduct the first telephone call on the handset and the second telephone call on the speakerphone.

### BRIEF DESCRIPTION OF THE DRAWINGS

FIG. 1 is a perspective view of a telephone that may be operated according to one or more embodiments of the invention.

FIG. 2 is an embodiment of a multi-user telephone system that includes a plurality of phones each connectable to a central control station.

FIG. 3 is a schematic diagram of an embodiment of a telephone system allowing a user to concurrently conduct multiple telephone calls, with each telephone call being carried on a separate telephone line.

FIG. 4 is a schematic diagram of an alternative embodiment of a telephone system for concurrently conducting more than one telephone call, with each telephone call being carried on a separate channel of the same telephone line.

FIG. 5 shows another embodiment of a telephone system having a wireless headset for listening to a call “hands-free.”

FIG. 6 is a schematic diagram of a computer system that may be included with a telephone system for operating the telephone system according to an embodiment of the invention.

FIG. 7 is a flowchart of a method of managing telephone calls according to one embodiment of the invention.

### DETAILED DESCRIPTION OF PREFERRED EMBODIMENTS

The invention provides ways to manage telephone calls to maximize productivity. Embodiments of the invention allow a telephone user to be simultaneously connected with one party on a handset of a telephone and to another party on the speakerphone of the same telephone. One application for this feature is a scenario in which a call is answered by an automated call answering system that informs the user that there will be some amount of waiting time until a representative will be able to answer the call. The system might also announce a predicted wait time, which may give the user an idea what tasks can be accomplished during the estimated hold time. Frequently, such a system will warn that hanging up and calling back will result in the caller being returned to the end of the queue. Accordingly, users desire to momentarily turn their attention to other tasks while monitoring the call.

The user in the preceding scenario might want to make another telephone call while continuing to monitor the first telephone call, to avoid losing his place in the call queue. According to one embodiment of the invention, the user may transfer the first telephone call to the speakerphone and place a second call on the handset. The user may then conduct the second telephone call using the handset while monitoring the first telephone call on the speakerphone. When a live representative finally answers on the first line, the user may excuse himself from the first telephone call and promptly speak to the representative. To keep one or both conversations private, the user may optionally activate a mute function that allows the user to selectively mute outbound audio communication on the speakerphone handling the audio signals for the first telephone call and/or mute outbound audio communication on the handset handling the audio signals for the second telephone call.

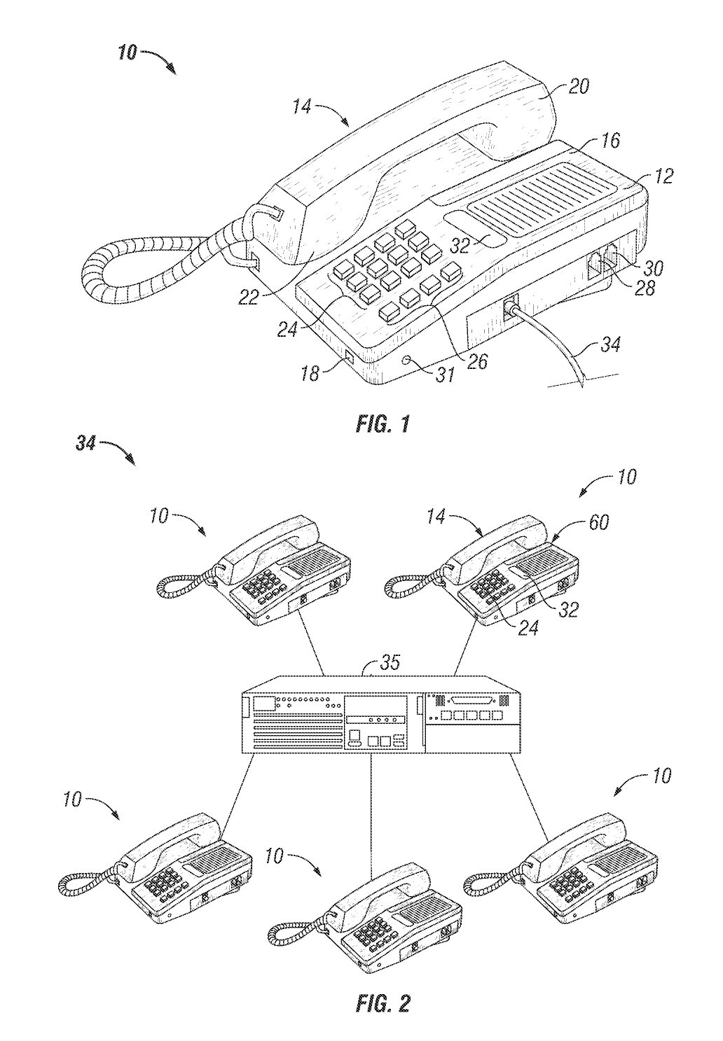

FIG. 1 is a perspective view of a telephone 10 that may be operated according to one or more embodiments of the invention. The telephone 10 has a familiar layout, including features similar to those found on conventional telephones. Conventional telephones include landline telephones, digital telephones that operate on Voice over Internet Protocol (VoIP), cellular phones. The telephone 10 includes a base 12, a handset 14, and a speakerphone. The speakerphone includes a loudspeaker 16 that produces sound from an inbound electronic communication or signal and a microphone 18 that produces an outbound electronic communication or signal from sound. Similarly, the handset 14 includes a receiver 20 that produces sound from an inbound electronic communication or signal and a transmitter 22 that produces an outbound electronic communication or signal from sound. A numeric keypad 24 may be used for entering alphanumeric data, such as dialing telephone numbers, responding to voice menu prompts, or navigating a menu of telephone functions. A set of function keys 26 may also be included to activate special functions of features of the telephone, such as redial, speed dial, mute, and line selection. An optional LCD 32 displays call-related information and other information, such as a visual representation of keys pressed, function menus, call status, and so forth. A first line port 28 may be used to connect with a first telephone extension, and a second line port 30 may be used to connect with a second telephone extension, using conventional telephone cables. The first and second line ports 28, 30 may be connected directly to a wall jack, or to the central control station of a multi-user telephone system. A power cord 34 provides electrical power to the telephone 10, such as for powering the LCD 32, a controller, and other electrical components.

A controller (not shown) electronically controls the functioning of the telephone 10. The telephone 10 may be a single-user telephone having a self-contained controller for electronically managing calls. The controller may include a microprocessor (CPU) residing in the base 12. In another embodiment, the telephone 10 may be a component of a multi-user telephone system having a central controller that electronically governs functionality of the telephone 10 and one or more other telephones. The controller of a multi-user system may reside on a central control station. In yet another embodiment, the controller may be a computer, such as a PC optionally including telephony software for controlling the telephone 10. For example, Voice over Internet Protocol (VoIP) technology allows calls to be carried over an internet connection using software and/or hardware to which the telephone 10 may be connected.

An optional headset port 31 is provided for connecting a headset to the telephone 10. The headset port 31 may include a jack for physically plugging in a device, or the headset port 31 may be an electronic node, access point, or other electronic feature not readily accessible to the user. The headset may be a wired or wireless headset. For example, a wired headset may plug directly into the headset port 31, allowing the user to listen privately to a telephone call. A Bluetooth device may instead be used with the headset port 31. For example, a Bluetooth transmitter may plug into the headset port 31 for transferring and receiving electromagnetic signals to and from a Bluetooth-enabled headset. Alternatively, a Bluetooth transmitter may be internally integrated with the telephone 10 so that the port 31 is not included. Calls may optionally be switched from the handset 14 to the headset or from the speakerphone 16, 18 to the headset. In another embodiment, the headset may allow for the monitoring of an optional third line or channel, as described below. For example, a first telephone call may be conducted or monitored on the handset 14, a second telephone call may be conducted or monitored on the speakerphone 16, 18, and a third telephone call may be conducted via a headset (such as through port 31), with as many as all three telephone calls being conducted concurrently.

FIG. 2 shows an embodiment of a multi-user telephone system 34. The multi-user telephone system 34 includes several telephones 10 each connectable to a central control station 35. One or more line ports may connect each telephone 10 with the central control station 35, and the central control station 35 may, in turn, be connected to one or more public telephone lines. A controller for controlling functional operation of the telephones 10 may reside on the central control station 35. For example, the controller may include at least one processor residing on the central control station 35, such as for governing global aspects of the telephone system 34 generally. The processor on the central control station 35 may govern the distribution and management of multiple public telephone lines serving the telephones 10. The system may also include a processor in each of the telephones 10 for governing other operational aspects of the telephones 10 individually. For example, a processor on each telephone 10 may communicate with a processor residing on the central control station 35, such as to interpret user input to the telephones 10 and to establish and maintain a connection between the central control station 35 and one of the telephones 10 during a call.

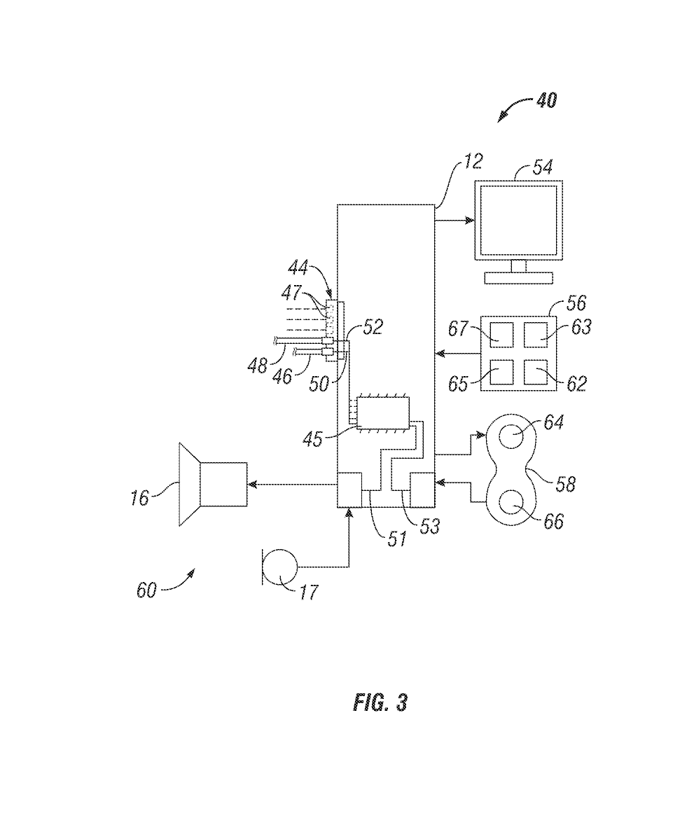

FIG. 3 is a schematic diagram of an embodiment of a telephone 40 allowing a user to simultaneously conduct multiple telephone calls. In this embodiment, each telephone call is carried on a separate telephone line, each of which are typically provided by a telecommunications provider to businesses and individual consumers to connect the telephone 10 to a telecommunication's network. A base 12 may provide a structural foundation for securing at least some physical components of the telephone 40. A handset 58 includes a receiver (speaker) 64 and a transmitter (microphone) 66. A speakerphone 60 includes a loudspeaker 16 and a microphone 17. The handset 58 and speakerphone 60 each allow two-way communication, i.e., inbound and outbound communication with another party to a telephone call. For example outbound communication includes outbound voice transmission to the other party, such as by speaking into the transmitter 66 while a call is connected to the handset 58 or speaking into the microphone 17 while a call is connected to the speakerphone 60. Inbound communication includes inbound audio communication, such as inbound voice, hold music, or other audio that may be heard through the receiver 64 of the handset 58 or the loudspeaker 16 of the speakerphone 60.

The base 42 may house at least some of the circuitry, such as a controller, used to implement various call-related features and functions of the telephone. The controller may include a processor 45, which is optionally disposed in the base 42, to control at least some of these features and functions. The processor 45 is in electronic communication with a terminal block 44, a display 54, a keypad 56, the handset 58, and the speakerphone 60. For example, the processor 45 may control how calls are routed to the handset 58 and the speakerphone 60, and how inbound voice communication is interpreted or transformed into sound at the handset 58 and the speakerphone 58. The processor 45 may also control other operational aspects of the telephone, such as operation of the display 54, interpretation of keystrokes entered on the keypad 56, and so forth.

The keypad 56 may include any number of alphanumeric keys and/or function keys. Various functions may be selected using the keypad 56. Some available functions may be displayed as options on a function menu on the display 54. The processor 45 may activate functions in response to a keystroke or sequence of keystrokes entered on the keypad 56. Examples of functions include redial, speed dial, mute, line select, “flash,” speakerphone on/off, and so forth. The term “keystroke sequence” is defined herein to include any number of keystrokes used to select or activate a function. Thus, some functions may be activated with a single keystroke. A set of operating instructions governing keystroke sequences and their associated functionality may be selected by a system designer and embedded in a logic circuit of the processor 45, and/or encoded on software used by the controller. The keystrokes and their associated functionality may also be programmed, modified, or customized by the user(s).

The terminal block 44 includes several line ports 47. Each line port 47 is configured for receiving a telephone cord that can carry at least one electronic telephone line. A first telephone cord 46 connects a first electronic telephone line (“Line 1”) to the telephone 40 at one of the line ports 47, which is in electronic communication with the processor 45 via an electrical connection 50. A second telephone cord 48 connects a second electronic telephone line (“Line 2”) to the telephone 40 at another one of the line ports 47, which is in electronic communication with the processor 45 via an electrical connection 52. The processor 45, in turn, is in electronic communication with the speakerphone 60 via an electrical connection 51 and with the handset 58 via an electrical connection 53. Each of the electrical connections may include a plurality of electronic communication pathways for carrying signals from the respective line port 47 to the processor 45. The processor 45 may thereby control how calls are routed between the terminal block 44 and the handset 58 or speakerphone 60. For example, the processor 45 may route a call from Line 1 to the handset 58 and route a call from Line 2 to the speakerphone 60 in response to user input on the keypad 56.

The processor 45 may be configured to process digital or analog telephone signals. If the telephone line 46, 48 connected to one of the line ports 47 carries a digital signal, then the processor 45 may, for example, decode inbound digital signals to transform them into audio at the receiver 64 of the handset 58 or at the loudspeaker 16 of the speakerphone 60. The processor 45 may likewise encode sound detected by the transmitter 66 of the handset 58 or the microphone 17 of the speakerphone 60 prior to transmitting signals to the other party of a call. If the telephone line 46, 48 connected to one of the line ports 47 carries an analog signal, then the receiver 64 of the handset 58 or the loudspeaker 16 of the speakerphone 60 may directly convert inbound signals to audio communication and the microphone of the speakerphone or the transmitter of the handset may generate the outbound signals. However, the processor 45 may still process the analog signals to some extent, such as by attenuating the volume or enhancing tonal characteristics of inbound or outbound communication, or by controlling whether a call is routed to the handset 58 or the speakerphone 60.

The processor 45 is configured to allow the user to selectively conduct separate and distinct calls on the handset 58 and the speakerphone 60 concurrently. For example, the user may place an outbound, first telephone call on Line 1 by lifting the handset 58, pressing a key 62 to select Line 1, and dialing a telephone number on the keypad 56. Alternatively, the first call may be an inbound call that the user receives on Line 1 by lifting the handset 58. The first call may be routed along the line cord 46, for example, and two-way communication may be conducted by listening through the receiver 64 and speaking through the transmitter 66 of the handset 58. A second, inbound or outbound telephone call may then be conducted on Line 2 without disconnecting or placing a hold on the call on Line 1. For example, an outbound call may be made with a keystroke sequence to access Line 2 on the speakerphone 60 and dialing a desired telephone number. Alternatively, if the second call is an inbound telephone call on Line 2, the second call may be received by pressing a keystroke sequence to route the inbound call to the speakerphone 60. Two-way communication may be conducted “hands-free” on the speakerphone by listening from a distance to the loudspeaker 16 and by speaking at a volume detectable by the microphone 17.

Advantageously, according to the invention, conducting the second call does not require disconnecting the first call or placing the first telephone call on hold. Rather, both calls may be conducted simultaneously. A user may continue to conduct the first telephone call through the handset 58, while conducting the second telephone call through the speakerphone 60. Alternatively, the user may switch the assignment of the first and second telephone calls among the handset and speakerphone, such as through another keystroke sequence. For example, if the first telephone call is in the middle of an extended wait time, such as with hold music playing through the receiver 64, the user may prefer to instead monitor the first telephone call on the loudspeaker 16 of the speakerphone 60 while conducting the second telephone call on the handset 58. To do so, the user may enter another keystroke sequence to switch Line 1 from the handset 58 to the speakerphone 60 and switch Line 2 from the speakerphone 60 to the handset 58. That way, the user may monitor the hold music on Line 1 “hands-free” on a loudspeaker 16 of the speakerphone 60, while conducting a conversation on Line 2 using the handset 58.

A user may selectively mute one or both of the telephone calls on Line 1 or Line 2. For example, while the user is carrying on a conversation on the handset 58 and monitoring hold music on the speakerphone 60, a live person may return to Line 1 being monitored on the speakerphone 60. At that point, the user may want to mute outbound communication on the handset 58 long enough to greet the person on the speakerphone 60. A handset mute function may be assigned to a key 63 for muting the handset 58. The user may, for instance, press the key 63 once to toggle “ON” the handset mute, then ask the person on the speakerphone 60 to wait a moment. Next, the user may want to mute outbound communication on the speakerphone 60 long enough to conclude the telephone call on the handset 58. The user may toggle “OFF” the handset mute by pressing the key 63 again, and then toggle “ON” a speakerphone mute function by pressing a key 65 assigned to this function. Once the user has hung up on the person on the handset 58, the user may toggle “OFF” the speakerphone mute by again pressing the key 65. The user may then resume the conversation with the person on Line 1. Furthermore, the user may continue the call on the speakerphone 60, or enter a keystroke sequence to transfer Line 1 back to the handset 58.

Optionally, a key 67 may be assigned to the function of switching calls between the handset 58 and the speakerphone 60. For example, the caller may press the key 67 to transfer Line 1 to the speakerphone 60 prior to making another call on Line 2 using the handset 58. In another scenario, the user may be speaking with a first party on Line 1 using the speakerphone 60 and answer a call from a second party on Line 2 using the handset 58. The user may desire to simultaneously switch the second party to the speakerphone 60 and the first party to the handset 58. The user may do so by executing another keystroke sequence assigned to that function. The display 54 may provide a menu for selecting such functions.

Because the keypad 56 may be used to make calls, perform functions, and so forth on more than one line, another key or key sequence may be pre-programmed to allow the user to select which line or phone call the keypad 56 is operative with. For example the keypad 56 may first be assigned to operate the handset on Line 1 during a first phone call, such as to dial a 10-digit phone number or to respond to voice-menu prompts from an answering system. A second call to be placed on Line 2 using the speakerphone 60 may require dialing another 10-digit number. However, the telephone 40 will typically require user input to switch the keypad 56 from operating Line 1 to operating Line 2. The input may simply be a button or switch located near the numeric portion of the keypad 56 to select whether the keypad 56 is operative with Line 1 or Line 2. Alternatively, the controller may be programmed to assign the keypad to the headset, handset or speakerphone based upon contextual information, such as which of the three devices is receiving the strongest voice input from the user or has a dial tone.

Telephone and computer technology has evolved in recent years to allow multiple “channels” of communication to be carried along a single telephone line. A conventional telephone line may carry as many as six or more channels. For example, on a DSL connection, filters are placed on a conventional telephone line to create several data channels and a voice channel on the same telephone line. The voice channel typically passes audio between 300 and 3,400 Hz, which is generally regarded as the range required for human speech to be clearly intelligible. The data channels operate on the remaining bandwidth, at higher frequencies. Combined, the data channels may achieve a relatively high rate of data transfer by transmitting data in parallel across the several data channels. For example, six channels each providing a data transfer rate of 50 kb/sec may be combined to produce a combined data transfer rate of 300 kb/sec. The channels may be separated according to a defined frequency range. On a DSL connection, voice communication may be assigned to a range of between 0 and 3.4 kHz, with higher frequencies used to transmit data.

In one embodiment of the invention, the extended bandwidth of a telephone line may be used to provide multiple voice channels on a single telephone line. Embodiments of the invention may, therefore, allow one telephone conversation to be conducted on one channel of a telephone line, while simultaneously allowing a second telephone conversation to be conducted on a second channel of the same telephone line, and so forth. Because data channels typically operate at frequencies above those used for most voice communication, voice communication may need to be digitally encoded in order to be carried on the additional channels. The digitally encoded signals may be transmitted at the higher frequency ranges along the digital channels. Subsequently, in much the same way that data channels get decoded by a DSL modem, the digitally encoded voice communication channels may subsequently be decoded by a telephone processor into distinct voice channels.

In one embodiment, the separate channels may be digitally encoded on a single phone line by a local phone company. A transmission line may extend from the phone company central office (CO) to a site, such as a home or an office building suite where a phone system according to the invention resides. A phone system controller at the site may then decode the channels and selectively route them to one or more phones. For example, the controller may route two of the channels to one telephone at the site along one or more wires, so that one of the two channels may be used for voice communication on a speakerphone and another of the two channels may be used for communication on a handset. In another embodiment, a phone company may provide separate telephone lines all the way to the site, where an upstream controller located at the site may then combine and digitally encode the multiple lines onto multiple channels of a single line. The single line may be routed from one location to another at the site, such as to one or more offices in a suite. Thus, the multiple channels of communication may be routed at the site more easily and with fewer wires than would be required to individually route each of the multiple lines provided by the phone company. The single line carrying the multiple channels may then be routed to a downstream controller, for separating and decoding the multiple channels and selectively routing them to one or more phones.

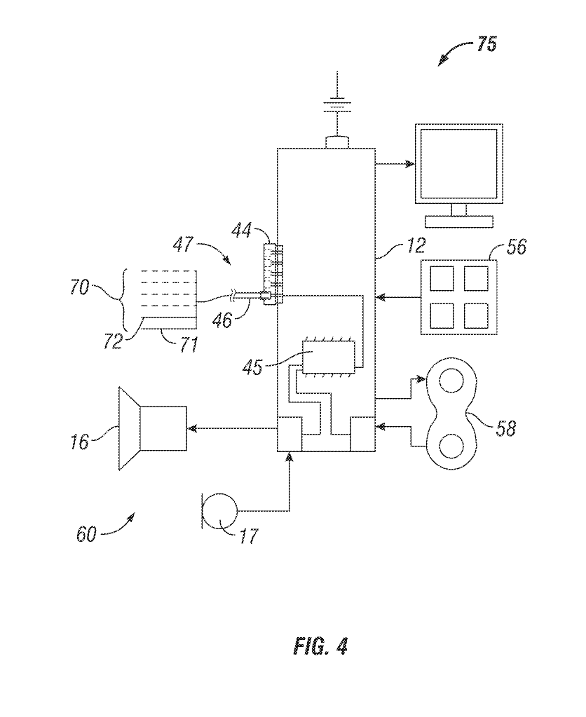

FIG. 4 is a schematic diagram of an embodiment of a telephone 75 for simultaneously conducting more than one telephone call, with each telephone call being carried on a separate channel of the same telephone line. Like reference numerals are used to designate components similar or identical to those shown in FIG. 3. In FIG. 4, only one telephone cord 46 is plugged into the terminal block 44, to emphasize how two telephone calls may be conducted simultaneously on separate channels of a single telephone line. The terminal block 44 may be located at the site where the telephone 75 resides. Circuitry on the processor 45 separates and decodes the six channels 70. A solid line 71 is drawn to indicate a “Channel 1” on which a first telephone call may be conducted. A solid line 72 is drawn to indicate a “Channel 2” on which a second telephone call may simultaneously be conducted. The six channels 70 may be carried along a single phone line from the phone company central office. Dashed lines are drawn for the remainder of the six channels 70, to indicate availability of those additional channels for carrying data or voice communication on the single telephone line.

To an end user, the telephone 75 of FIG. 4 may operate similarly or identical to the telephone system 40 of FIG. 3. Telephone calls may still be conducted on the handset 58 and the speakerphone 60, either individually or simultaneously, as with embodiments using multiple telephone lines. However, in the embodiment of FIG. 4, the telephone calls are now routed along channels of a single telephone line, rather than on separate telephone lines. For example, an outbound telephone call may be placed on Channel 1 by lifting the handset 58, pressing a key 62 to select Channel 1 (or allowing the system to default to Channel 1), and dialing a telephone number on the keypad 56. Alternatively, an inbound telephone call on Channel 1 may be received by lifting the handset 58 and optionally pressing a key to select Channel 1. The first call may be routed along the line cord 46. Two-way communication may be conducted by listening through the receiver 64 and speaking through the transmitter 66 of the handset 58.

A second telephone call may be placed or received on Channel 2 without disconnecting or holding the call on Channel 1. For example, an outbound call may be made by pressing a keystroke sequence to access Channel 2 on the speakerphone 60 and dialing a desired telephone number. Alternatively, if the second call is an inbound telephone call on Channel 2, the second call may be received by pressing a keystroke sequence to route the inbound call to the speakerphone 60. Two-way communication may be conducted “hands-free” on the speakerphone by listening from a distance to the loudspeaker 16 and by speaking at a volume detectable by the microphone 17.

The telephone 75 embodied in FIG. 4 desirably makes use of more of the bandwidth available on a telephone line for making and receiving multiple telephone calls. By filtering or otherwise dividing a single telephone line into multiple channels, a stand-alone telephone having a single line may effectively emulate a telephone having multiple telephone lines. This feature desirably makes embodiments of the invention that more accessible to the average user, such as individuals with households wired with only one telephone line. This feature is also advantageous when used in multi-line, multi-user telephone systems, by multiplying the number of effective telephone lines available from each telephone line. Thus, for example, businesses may expand their call capacity without purchasing costly additional lines.

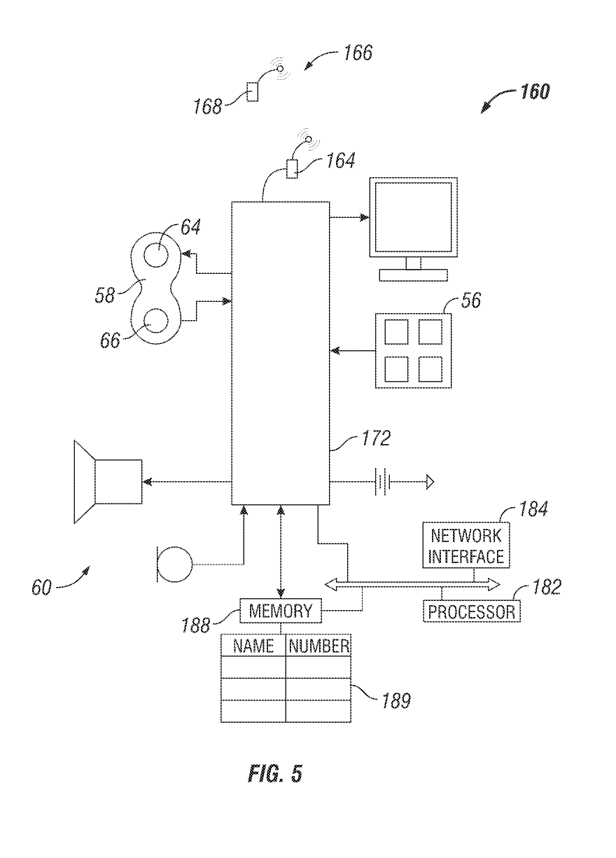

FIG. 5 shows another embodiment of a telephone system 160 having a wireless headset 166 for listening to a call “hands-free.” The wireless headset 166 includes a wireless base transceiver 164 and a wireless headset transceiver 168 configured for wireless communication with each other. The types of headsets that may be used include stereo ear telephones or an earpiece to fit a single ear. The base transceiver 164 and headset transceiver 168 may communicate using Bluetooth or other wireless technology. The wireless transceivers 164, 168 are not to be confused with the transmitter 64 and receiver 66 of the handset 64, whose purpose and function is described in connection with the embodiments of FIGS. 3 and 4. A controller 172 includes a processor (CPU) 182 in electronic communication with a network interface 184. The network interface 184 allows the telephone 160 to be connected, for example, to a VoIP telephone line. The controller 172 is also in communication with a memory module 188. An electronic database may reside on the memory module 188, and may include data such as names of parties and their telephone numbers.

The controller 172 is configured to optionally route calls to the wireless headset 166. A user wearing the wireless headset 166 may thereby listen and speak to another party during a telephone call, as an alternative to doing so on the handset 58 or the speakerphone 60. The controller 172 may, for example, route an incoming telephone call to the wireless headset 166, or may transfer an existing call from the speakerphone 60 or handset 58 to the wireless headset 166. In another embodiment, two or more calls may be conducted concurrently. For example, the controller 172 may route a first call to the speakerphone 60 and a second call to the wireless headset 166. The controller 172 may instead route a first call to the handset 58 and a second call to the wireless headset 166, in which case a single-ear headset 166 may be preferred, so that one call may be monitored in one ear using the wireless headset 166 and the other call may be conducted with the other ear using the handset 58. In another embodiment, the controller 172 may actually conduct three different telephone calls concurrently, one to each of the handset 58, the speakerphone 60, and to the wireless headset 166. As with the embodiments of FIGS. 3-4, the user may select how the calls are routed by inputting commands or selecting functions using the keypad 56. Alternatively, the controller may be programmed with default instructions for assigning initial and subsequent calls to the various audio interfaces (headset, handset or speakerphone) that may be overridden my user input using one or more key or buttons.

It should be recognized that the invention may include both hardware and software elements. For example, in the embodiments of FIGS. 1-4, the controller may be operated in accordance with instructions embodied in software maintained in memory residing in the base of a single-user telephone, on a central control station of a multi-user telephone system, or on a computer configured for VoIP to control one or more telephones. Software used to implement the invention may also include firmware, resident software and microcode.

The invention can also take the form of a computer program product accessible from a computer-readable medium providing program code for use by or in connection with a computer or any instruction execution system. For the purposes of this description, a computer-usable or computer readable medium can be any apparatus that can contain, store, communicate, propagate or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters. For example, a network adapter may connect a telephone system to the internet to enable a VoIP connection.

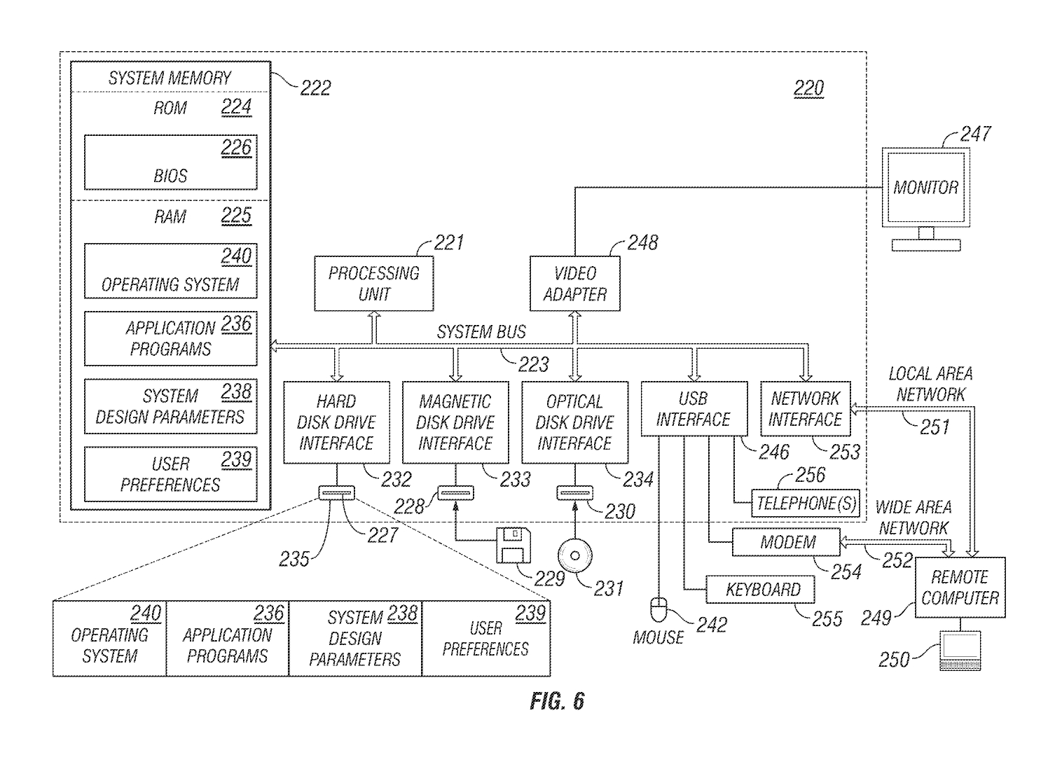

To illustrate, FIG. 6 is a schematic diagram of a computer system generally indicated at 220 that may be configured for operating a telephone system according to an embodiment of the invention. The computer system 220 may be a general-purpose computing device in the form of a conventional computer system 220. Generally, computer system 220 includes a processing unit 221, a system memory 222, and a system bus 223 that couples various system components, including the system memory 222 to processing unit 221. System bus 223 may be any of several types of bus structures including a memory bus or memory controller, a peripheral bus, and a local bus using any of a variety of bus architectures. The system memory includes a read only memory (ROM) 224 and random access memory (RAM) 225. A basic input/output system (BIOS) 226, containing the basic routines that help to transfer information between elements within computer system 220, such as during start-up, is stored in ROM 224.

Computer system 220 further includes a hard disk drive 235 for reading from and writing to a hard disk 227, a magnetic disk drive 228 for reading from or writing to a removable magnetic disk 229, and an optical disk drive 230 for reading from or writing to a removable optical disk 231 such as a CD-R, CD-RW, DV-R, or DV-RW. Hard disk drive 235, magnetic disk drive 228, and optical disk drive 230 are connected to system bus 223 by a hard disk drive interface 232, a magnetic disk drive interface 233, and an optical disk drive interface 234, respectively. Although the exemplary environment described herein employs hard disk 227, removable magnetic disk 229, and removable optical disk 231, it should be appreciated by those skilled in the art that other types of computer readable media which can store data that is accessible by a computer, such as magnetic cassettes, flash memory cards, digital video disks, Bernoulli cartridges, RAMs, ROMs, USB Drives, and the like, may also be used in the exemplary operating environment. The drives and their associated computer readable media provide nonvolatile storage of computer-executable instructions, data structures, program modules, and other data for computer system 220. For example, the operating system 240 and application programs 236 may be stored in the RAM 225 and/or hard disk 227 of the computer system 220.

A user may enter commands and information into computer system 220 through input devices, such as a keyboard 255 and a mouse 242. Telephone commands and other information may be input using the telephone keypads discussed in relation to FIGS. 1-4. Other input devices (not shown) may include a microphone, joystick, game pad, touch pad, satellite dish, scanner, or the like. These and other input devices are often connected to processing unit 222 through a USB (universal serial bus) 246 that is coupled to the system bus 223, but may be connected by other interfaces, such as a serial port interface, a parallel port, game port, or the like. One or more telephones 256 may also be connected to the computer system 220 via the USB interface and/or the network interface 253. A display device 247 may also be connected to system bus 223 via an interface, such as a video adapter 248. In addition to the monitor, personal computers typically include other peripheral output devices (not shown), such as speakers and printers.

The computer system 220 may operate in a networked environment using logical connections to one or more remote computers 249. Remote computer 249 may be another personal computer, a server, a client, a router, a network PC, a peer device, a mainframe, a personal digital assistant, an internet-connected mobile telephone or other common network node. While a remote computer 249 typically includes many or all of the elements described above relative to the computer system 220, only a memory storage device 250 has been illustrated in FIG. 5. The logical connections depicted in the figure include a local area network (LAN) 251 and a wide area network (WAN) 252. Such networking environments are commonplace in offices, enterprise-wide computer networks, intranets, and the internet.

When used in a LAN networking environment, the computer system 220 is often connected to the local area network 251 through a network interface or adapter 253. When used in a WAN networking environment, the computer system 220 typically includes a modem 254 or other means for establishing high-speed communications over WAN 252, such as the internet. Modem 254, which may be internal or external, is connected to system bus 223 via USB interface 246. In a networked environment, program modules depicted relative to computer system 220, or portions thereof, may be stored in the remote memory storage device 250. It will be appreciated that the network connections shown are exemplary and other means of establishing a communications link between the computers may be used.

Program modules may be stored on a hard disk 227, an optical disk 231, ROM 224, RAM 225, or even a magnetic disk 229. The program modules may include portions of an operating system 240, application programs 236, or the like. A system design database 238 may be included, which may contain pre-programmed functions selected by a system designer for operating a telephone system. A user preferences database 239 may also be included, which may contain other user-selected parameters and procedures for operating a telephone system.

Aspects of the present invention may be implemented in the form of application program 236. Application program 236 may be informed by or otherwise associated with the system design database 238, and/or the user preferences database 239. The application program 236 generally comprises computer-executable instructions for operating the telephone, such as for connecting calls, routing a call to a speakerphone or handset, and governing other aspects of a telephone system operation according to the invention.

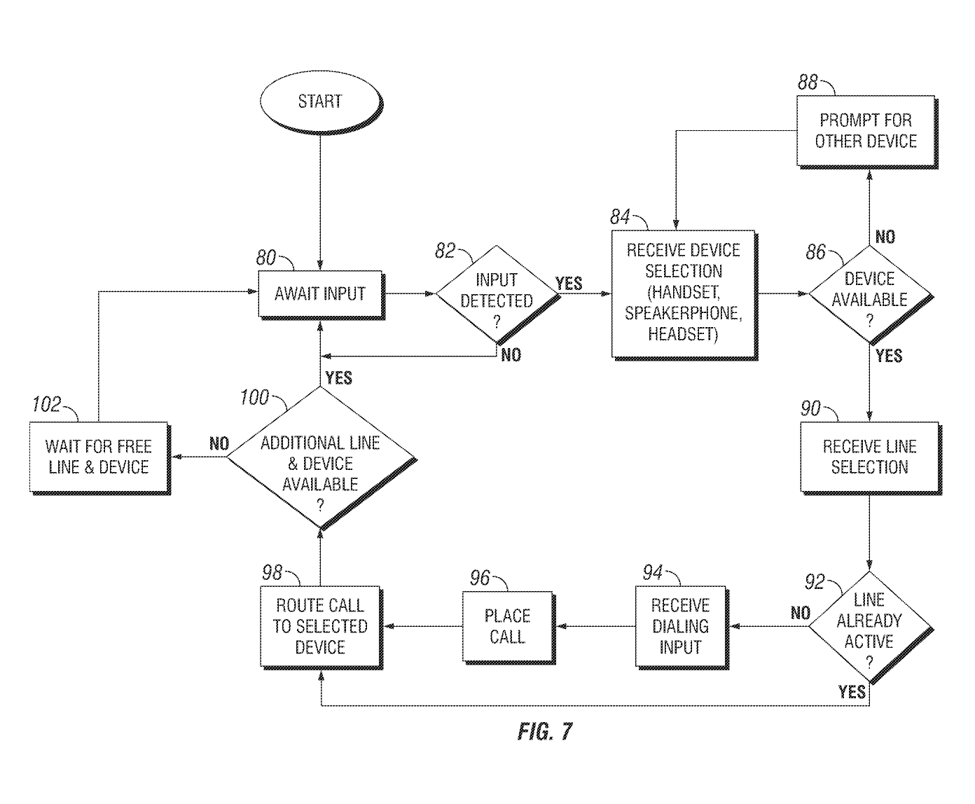

FIG. 7 is a flowchart of a method of managing calls according to one embodiment of the invention. The method may be performed by hardware and/or software such as that illustrated in FIG. 6. A telephone system is configured to await user input in step 80. The input will be used to place and/or route calls. If input is detected in step 82, the telephone begins receiving this input in subsequent steps. In step 84, input is received regarding the desired device, which is typically a handset, a speakerphone, or a headset. For example, the telephone may sense that a handset was picked up, indicating an intent to use the handset. Alternatively, the telephone may sense that a speakerphone selection button or a headset selection button was pressed, signaling an intent to use the speakerphone or headset. If the selected device (handset, speakerphone, or headset) is not available in step 84, the telephone may prompt the user to select another device (step 88). For example, if a call is already active on the speakerphone, pressing a speakerphone selection button may have no effect. Likewise, if a wired headset is not plugged in to a headset port, or if no Bluetooth headset is detected within transmission range of the telephone, then pressing a headset selection button may also have no effect.

If the desired device is available in step 86, then the telephone may next receive line selection input in step 90. Line selection input may include, for example, a signal received in response to the pressing of a line selection button. If the requested line is already active (step 92), then the telephone may directly connect the selected device to the selected line in step 98. This may occur, for example, when the user desires to pick up a call that the user or another user on the phone system had previously placed on hold. Once that call is routed to the user's selected device, the user may simply begin talking to the party who was on hold. Alternatively, if the selected line is not already active in step 92, then the telephone awaits dialing input in step 94. Dialing input may include the pressing of numeric keys on the phone pad, or it may include the selection of a party's phone number from a phonebook stored in the telephone's memory. When sufficient dialing information is received, the telephone may place the call in step 96. Then, in step 98, the telephone may route the newly placed call to the selected device.

The telephone according to this embodiment is capable of operating more than one phone call concurrently. Thus, the telephone may receive further input regarding additional phone calls. In step 100, the telephone checks to see if an additional line and any of the devices are available. If not, then the telephone waits for at least one line and one device to become available in step 102 before returning to step 80. For example, if calls are already active on the handset, speakerphone, and headset, the telephone may ignore any input indicating a desire to place a new call on either of those three devices. If one or more devices are available, but there are no free lines available, then the telephone may also ignore any input indicating a desire to place a new call. Once at least one line and one device is available, the telephone may repeat portions of the method outlined in FIG. 7, beginning again with step 80. Thus, for example, a first call may be placed on the handset, and a second call may be placed on the speakerphone, such that both calls and devices are operated concurrently.

The invention, in its array of embodiments, will improve the way calls are conducted. The invention will also improve productivity of telephone users. By allowing a user to simultaneously conduct two telephone calls on a single telephone, the user may get more tasks accomplished in less time or with less equipment. In particular, it is highly desirable to be able to monitor one telephone call hands-free on a speakerphone while carrying on a conversation on a handset. A telephone system according to the invention is more functional and versatile. The ability to switch telephone calls between the speakerphone and handset is convenient, particularly when conducting two calls at the same time. An interactive system including a function menu and keypad enhances the functionality and ease of use. These and other advantages will be apparent to one of ordinary skill in the art having benefit of this disclosure. However, none of the advantages listed are necessarily intended in a limiting sense.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A telephone system, comprising:
a handset configured for two-way audio communication;
a speakerphone configured for two-way audio communication;
a controller in electronic communication with the handset and with the speakerphone, wherein the controller is configured for conducting a first call on the handset and a second call on the speakerphone concurrently.

2. The telephone system of claim 1, wherein the controller is configured to carry the first call on a first telephone line and to carry the second call on a second telephone line.

3. The telephone system of claim 1, wherein the controller is configured to selectively carry the first call on a first channel and to carry the second call on a second channel, wherein the first and second channels reside on the same telephone line.

4. The telephone system of claim 1, further comprising:
a headset port in electronic communication with the controller, wherein the controller is configured to selectively route telephone calls to the headset port.

5. The telephone system of claim 4, wherein the controller is configured for concurrently conducting two or more of the first call on the handset, the second call on the speakerphone, and a third call on the headset port.

6. The telephone system of claim 4, further comprising a wireless transmitter in communication with the headset port and a wireless receiver configured for wireless communication with the wireless transmitter.

7. The telephone system of claim 6, wherein the wireless transmitter and the wireless receiver are configured for communicating with one another using Bluetooth.

8. The telephone system of claim 1, further comprising a central control station configured for controlling calls on a plurality of handset and speakerphone pairs.

9. The telephone system of claim 1, further comprising one or more function keys in electronic communication with the controller, wherein the controller is configured to perform one or more functions in response to one or more keystroke sequences.

10. The telephone system of claim 9, wherein the controller is configured to selectively mute outbound audio communication through at least one of the handset and the speakerphone in response to one of the keystroke sequences.

11. The telephone system of claim 9, wherein the controller is configured to selectively re-route a first call from the speakerphone to the handset and to re-route a second call from the handset to the speakerphone in response to one of the keystroke sequences.

12. The telephone system of claim 9, wherein the controller is user-programmable to selectively assign the one or more predefined keystroke sequences to the one or more functions.

13. A method, comprising:
routing a first telephone call to a handset of a telephone;
routing a second telephone call to a speakerphone of the telephone; and
concurrently conducting the first telephone call on the handset and conducting the second telephone call on the speakerphone.

14. The method of claim 13, further comprising routing a third telephone call to a headset port of the telephone and concurrently conducting the first telephone call on the handset, the second telephone call on the speakerphone, and the third call on the headset.

15. The method of claim 13, further comprising:
carrying the first telephone call on a first telephone line; and
carrying the second telephone call on a second telephone line.

16. The method of claim 13, further comprising:
carrying the first telephone call on a first channel of a telephone line; and
carrying the second telephone call on a second channel of the telephone line.

17. A machine-accessible medium containing instructions, which when executed by a machine, cause the machine to perform operations, comprising:
routing a first telephone call to a handset of a telephone;
routing a second telephone call to a speakerphone of the telephone; and
concurrently conducting the first telephone call on the handset and conducting the second telephone call on the speakerphone.

18. The machine-accessible medium of claim 17, wherein the operations further comprise routing a third telephone call to a headset port of the telephone and concurrently conducting the first telephone call on the handset, the second telephone call on the speakerphone, and the third call on the headset.

19. The machine-accessible medium of claim 17, wherein the operations further comprise:
carrying the first telephone call on a first telephone line; and
carrying the second telephone call on a second telephone line.

20. The machine-accessible medium of claim 17, wherein the operations further comprise:
carrying the first telephone call on a first channel of a telephone line; and
carrying the second telephone call on a second channel of the telephone line.
